(19) United States
(12) Patent Application Publication
(10) Pub. No.: US 2002/0140865 A1
(43) Pub. Date: Oct. 3, 2002

(54) Method of correcting color saturation of video signals

(75) Inventors: Tomoyoshi Matsushita, Minato-ku (JP); Shigeru Fujino, Minato-ku (JP); Jimmie D. Songer, Itasca, IL (US)

Correspondence Address: SUGHRUE MION, PLLC, 2100 PENNSYLVANIA AVENUE, N.W., WASHINGTON, DC, 20037, US

(73) Assignee: NEC VIEWTECHNOLOGY, Ltd.

(21) Appl. No.: 10/103,788

(22) Filed: Mar. 25, 2002

(30) Foreign Application Priority Data
Mar. 30, 2001 (JP) 2001-100003

(51) Int. Cl. H04N 5/21

(52) U.S. Cl. 348/631; 348/703

(57) ABSTRACT

A color saturation correction method is provided that, by means of a simple circuit configuration, can reduce dissimilarities in picture quality between images that are projected from film and images obtained from video signals, caused by over-saturation of colors in dark scenes. The luminance signal level of a video signal is detected and the saturation of colors in dark portions is then corrected by reducing the chrominance signal level depending on a luminance signal level when the luminance signal level is at or below a predetermined level. The luminance level at which adjustment starts is preferably set to 50% or lower, and the chrominance signal output gain is preferably −3 dB or greater.

### BACKGROUND OF THE INVENTION

The present invention relates to a technique for correcting video signals, and more particularly to a technique for correcting video signals that remedies over-saturation of color tones in dark scenes.

In recent years, an increase in the size of screens of television sets for home use, the steadily dropping price of plasma displays and projectors, and the increasing number of movies that are broadcast by satellite broadcast or cable TV have all contributed to a growing demand for a movie-viewing experience in the home that approaches the ambience of a movie theater. In video signals that are received in the home, however, coloring may frequently appear deep in the remembrance colors, particularly in human skin tones, in dark scenes. As a result, the picture quality of video signals that are received in the home is different from images that are shown in, for example, a movie theater.

Japanese Patent Laid-open No. 229788/92 discloses a method for solving the above-described problem in which gradation of a luminance signal is corrected depending on the mean luminance level of the input luminance signal, and the gain of the chrominance signal is varied depending on this gradation correction to compensate for the drop in relative color gain that accompanies gradation correction. However, since gain of chrominance signals is varied based on the mean luminance level, compensation may be appropriate for some colors but over-saturated for others, and reproducing natural colors is therefore problematic.

Japanese Patent Laid-open No. 84041/97 discloses a video signal processing circuit having a gradation correction means for correcting gradation of a luminance signal, a gain conferring means that assigns gain to a chrominance signal, and a correction means. In this video signal processing circuit, gradation of a luminance signal is first corrected by the gradation correction means; following which the gain generating means generates the gain of the chrominance signal depending on the magnitude of change in the luminance signal level before and after gradation correction; and the gain of the chrominance signal is then corrected by the correction means. However, the correction of gradation followed by the correction of gain results in the problems of complex circuit structure and complex correction conditions.

It is an object of the present invention to provide a method of correcting the color saturation of video signals by means of a simple circuit configuration, capable of reducing the dissimilarities in picture quality that have conventionally occurred between images created by projection through a film and images obtained from video signals; capable of displaying-images from video signals with subdued coloring without causing color over-saturation in dark scenes of the images; and capable of reproducing the picture quality that approaches the quality of pictures shown in, for example, a movie theater.

### SUMMARY OF THE INVENTION

In order to solve the above-described problems the method of correcting color saturation of the present invention is directed toward detecting the luminance signal level of a video signal that includes a luminance signal and a chrominance signal, varying the chrominance signal level depending on the detected luminance signal level, and supplying the result as output.

Varying a chrominance signal depending on the level of the luminance signal enables adjustment of color saturation in a portion of a specific brightness to allow display of images of subdued coloring.

Further, in the method of correcting color saturation according to the present invention, the level of the chrominance signal is varied when the luminance signal level is equal to or lower than a prescribed level.

The variation of the level of the chrominance signal at or below a particular luminance signal level in this way enables adjustment of color saturation in portions that are at or below this level of brightness, thereby bringing about display of images having subdued coloring.

Further, in the method of correcting color saturation of the present invention, the prescribed level of the luminance signal level is preferably equal to or less than 50%.

Variation of chrominance signal level only when the luminance signal level is equal to or less than 50% allows the adjustment of color saturation to be prevented in bright portions and can bring about display of images of more subdued coloring.

The variation of chrominance signal level is preferably realized by multiplying the chrominance signal level by a coefficient to vary the chrominance signal level.

This method of multiplying by a coefficient to reduce the chrominance signal offers an advantage of bringing about the display of an image of subdued coloring by means of a simple circuit.

In addition, the coefficient is preferably equal to or less than 0.75 when the luminance signal level is 0.

Making the color saturation in the darkest areas 75% or less in this way enables display of images with subdued coloring.

In addition, the coefficient is preferably generated in accord with a function or with reference to a look-up table.

Generating the coefficient by means of a look-up table in this way can facilitate a complex variation of a chrominance signal level.

A color saturation correction device according to the present invention includes:

a Y/C separator circuit for separating the luminance signal and chrominance signal of a video signal;

a signal level detector for receiving as input the luminance signal that has been separated by the Y/C separator circuit and detecting the luminance signal level;

a coefficient generator for calculating the gain of the chrominance signal output level depending on the luminance signal level; and

a level control unit for receiving as input the chrominance signal that has been separated by means of the Y/C separator circuit, multiplying the chrominance signal level by said gain of the chrominance signal output level, and supplying the result as output of said color saturation correction device.

The above and other objects, features, and advantages of the present invention will become apparent from the following description referring to the accompanying drawings that illustrate an example of a preferred embodiment of the present invention.

### BRIEF DESCRIPTION OF THE DRAWINGS

FIG. 1 is a graph showing the adjustment pattern of the chrominance signal output gain.

FIG. 2 is a graph showing the adjustment pattern of the chrominance signal output level.

FIG. 3 is a block diagram showing a device for correcting color saturation of chrominance signals.

FIG. 4 shows an example of an output gain pattern of a chrominance signal plotted against an input level of a luminance signal, tabulated in a look-up table.

### DETAILED DESCRIPTION OF THE PREFERRED EMBODIMENTS

Embodiments of the present invention are next described with reference to the accompanying figures.

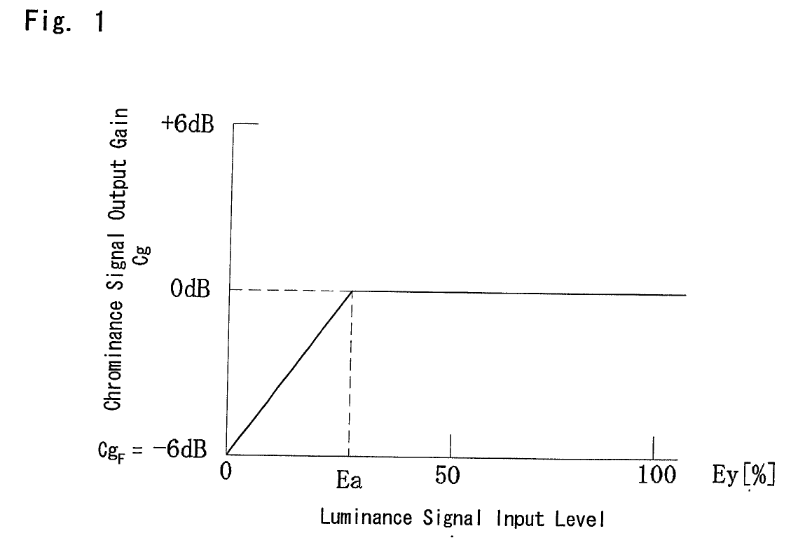

We now refer to FIG. 1, which is a graph showing an example of the adjustment pattern of the chrominance signal output gain, this chrominance signal output gain being represented as a function of the level of the luminance signal input.

In the present invention, video signals are separated into luminance signal Y and chrominance signal C by means of a Y/C separator circuit, following which the output gain Cg of the chrominance signal is adjusted as a function of the input level Ey of luminance signal Y such that an output level of the chrominance signal is reduced in dark portions of an image.

In FIG. 1, the luminance signal input level Ea at which adjustment of the output gain of the chrominance signal starts is set to 25%, and the output gain of the chrominance signal when the luminance signal input level is 0% (i.e., when the luminance signal level is at a minimum) is set to −6 dB. Hereinafter, the chrominance signal output gain for the minimum luminance signal level is referred to as a final chrominance signal output gain Cg_{F}.

In the example shown in FIG. 1, chrominance signal output gain Cg is 0 dB when luminance signal input level Ey is equal to or greater than Ea, wherein the input level and output level of the chrominance signal is identical. When the input level Ey of the luminance signal is less than Ea, the dB value of the output gain Cg of the chrominance signal decreases linearly with respect to the input level Ey of the luminance signal. When Cg is equal to −6 dB, the output level is approximately one-half the input level.

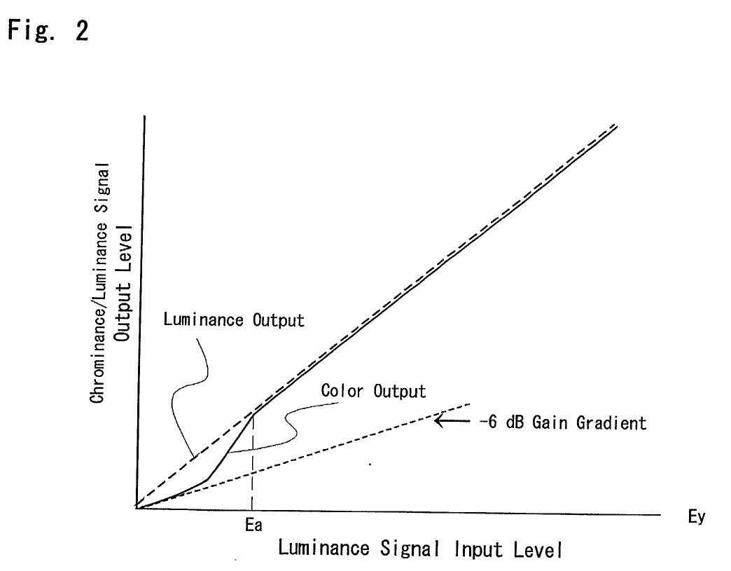

In case that the relation between the input level of the luminance signal and the output gain of the chrominance signal is represented by the graph of FIG. 1, the relation between the input level of the luminance signal and the output level of the chrominance signal is as represented in the graph of FIG. 2. Here it can be seen that the output level of the chrominance signal decreases in the domain in which the input level of the luminance signal is equal to or lower than the luminance signal input level Ea. Since the degree of decrease in the chrominance signal output level is determined by chrominance signal output gain Cg, the output level of the chrominance signal is suppressed as low as the −6 dB gain gradient line shown in FIG. 2.

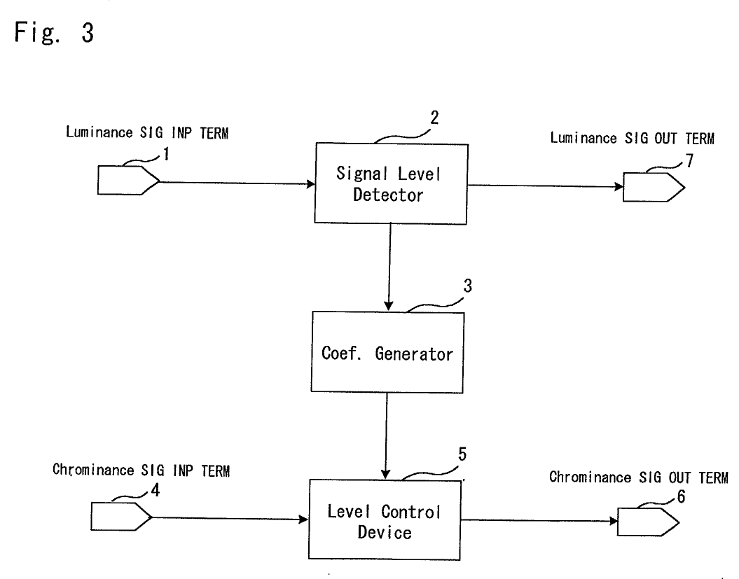

FIG. 3 is a block diagram of a device for adjusting the output gain of a chrominance signal depending on the input level of a luminance signal as shown in FIG. 1. Signal level detector 2 detects the level of the luminance signal applied to luminance signal input terminal 1. Coefficient generator 3 generates an output gain coefficient for the chrominance signal based on the level of the luminance signal, wherein coefficient generator 3 generates the coefficient in accordance with a prescribed function. Alternatively, coefficient generator 3 may incorporate a look-up table and generate a coefficient in accordance with the table. Level control device 5, responsive to the output gain coefficient, controls the level of the chrominance signal that has been received from chrominance signal input terminal 4 and supplies the level-controlled chrominance signal as an output from chrominance signal output terminal 6. The luminance signal received from luminance signal input terminal 1 is provided without change as an output from luminance signal output terminal 7.

As a working example, images were displayed on a television set in which the chrominance signal was corrected by means of the luminance-dependent color saturation correction circuit shown in FIG. 3. The images then subjectively evaluated (visually evaluated) while varying the setting of the output gain coefficient generated by coefficient generator 3. The results of this evaluation showed that image colors in bright portions became too light when the input level of a luminance signal at an adjustment start Ea was set to 50% or greater, and further, the problem of saturation of image colors in dark portions was not solved when final chrominance signal output gain Cg_{F} was −3 dB or greater.

As a result, in order to prevent the over-saturation of colors in dark portions of an image, prevent the lightening of colors in bright portions of an image, and enable display of a natural image that approximates film projection in a movie theater, the ranges of the input level of a luminance signal at an adjustment start Ea and final chrominance signal output gain Cg_{F} are preferably set to:

Ea≦50% and

Cg_{F}≦−3 dB or≦0.75

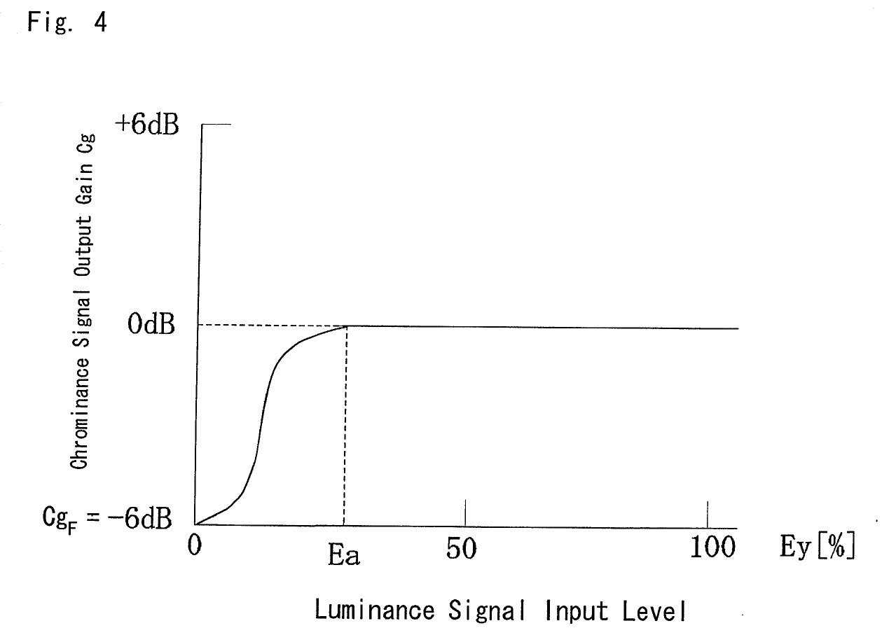

FIG. 4 shows an example of an output gain of a color signal plotted against an input level of a luminance signal, tabulated in a look-up table provided in coefficient generator 3. Generation of coefficients by means of a look-up table enables more complex control of chrominance signal levels than can be achieved by using a function as shown in FIG. 1.

It is to be understood, however, that although the characteristics and advantages of the present invention have been set forth in the foregoing description, the disclosure is illustrative only, and changes may be made within the scope of the appended claims.

What is claimed is:

1. A method of correcting saturation of a color signal generated from a video signal, the method comprising steps of:
detecting luminance signal level of a video signal that includes a luminance signal and a chrominance signal; and
varying the level of the chrominance signal depending on said luminance signal level.

2. A method of correcting saturation of a color signal as claimed in claim 1, wherein said chrominance signal level is varied when said luminance signal level is equal to or lower than a predetermined level.

3. A method of correcting saturation of a color signal as claimed in claim 2, wherein the maximum of said luminance signal level at which said chrominance signal level is varied is 50% or less.

4. A method of correcting saturation of a color signal as claimed in claim 1, wherein the variation of said chrominance signal level is effected by multiplying said chrominance signal level by a coefficient to decrease said chrominance signal level.

5. A method of correcting saturation of a color signal as claimed in claim 2, wherein the variation of said chrominance signal level is effected by multiplying said chrominance signal level by a coefficient to decrease said chrominance signal level.

6. A method of correcting saturation of a color signal as claimed in claim 3, wherein the variation of said chrominance signal level is effected by multiplying said chrominance signal level by a coefficient to decrease said chrominance signal level.

7. A method of correcting saturation of a color signal as claimed in claim 4, wherein said coefficient is 0.75 or less when said luminance signal level is 0.

8. A method of correcting saturation of a color signal as claimed in claim 5, wherein said coefficient is 0.75 or less when said luminance signal level is 0.

9. A method of correcting saturation of a color signal as claimed in claim 6, wherein said coefficient is 0.75 or less when said luminance signal level is 0.

10. A method of correcting saturation of a color signal as claimed in claim 4, wherein said coefficient is generated by means of a function or a look-up table.

11. A method of correcting saturation of a color signal as claimed in claim 5, wherein said coefficient is generated by means of a function or a look-up table.

12. A method of correcting saturation of a color signal as claimed in claim 6, wherein said coefficient is generated by means of a function or a look-up table.

13. A method of correcting saturation of a color signal as claimed in claim 7, wherein said coefficient is generated by means of a function or a look-up table.

14. A method of correcting saturation of a color signal as claimed in claim 8, wherein said coefficient is generated by means of a function or a look-up table.

15. A method of correcting saturation of a color signal as claimed in claim 9, wherein said coefficient is generated by means of a function or a look-up table.

16. A device for correcting saturation of a color signal comprising:
a Y/C separator circuit for separating a luminance signal and a chrominance signal of a video signal;
a signal level detector for receiving a luminance signal that has been separated by said Y/C separator circuit and detecting the luminance signal level;
a coefficient generator for calculating a gain of chrominance signal output level which corresponds to said luminance signal level; and
a level control unit for receiving a chrominance signal that has been separated by means of said Y/C separator circuit, multiplying the chrominance signal level by said gain of the chrominance signal output level, and supplying the result as a saturation-corrected color signal.
